(19) United States
(12) Patent Application Publication
(10) Pub. No.: US 2022/0195085 A1
(43) Pub. Date: Jun. 23, 2022

(54) RAPID DISSOLUTION OF DRAG-REDUCING AGENTS AT LOW TEMPERATURES

(71) Applicant: Liquidpower Specialty Products Inc., Houston, TX (US)

(72) Inventors: Rajesh K. MALLAVAJULA, Stillwater, OK (US); Raymond L. JOHNSON, Ponca City, OK (US); Mark CAREL, Ponca City, OK (US); Michael L. Olechnowicz, Ponca City, OK (US)

(21) Appl. No.: 17/557,533

(22) Filed: Dec. 21, 2021

Related U.S. Application Data
(60) Provisional application No. 63/129,803, filed on Dec. 23, 2020.

(51) Int. Cl. C08F 210/14; F17D 1/16

(52) U.S. Cl. CPC C08F 210/14; F17D 1/16

(57) ABSTRACT

Drag-reducing polymers and methods of manufacturing drag-reducing polymers are provided. In one aspect, an ultra-high molecular weight terpolymer useful as a drag reducer for hydrocarbons having a molecular weight greater than 1 million is provided. The terpolymer includes (a) a first monomer including a first alpha-olefin monomer having a carbon chain length of between 4 and 9 carbon atoms. The terpolymer further includes (b) a second monomer including a second alpha-olefin monomer having a carbon chain length of between 12 and 15 carbon atoms. The terpolymer further includes (c) a third monomer including a third alpha-olefin monomer having a carbon chain length of between 10 and 11 carbon atoms, wherein the second monomer is present at greater than or at 15% (molar content).

### CROSS-REFERENCE TO RELATED APPLICATION

This application claims benefit of U.S. Provisional Patent Application No. 63/129,803, filed on Dec. 23, 2020, which application is incorporated herein by reference in its entirety.

### BACKGROUND

### Field

Implementations of the present disclosure generally relate to drag-reducing polymers and methods of manufacturing drag-reducing polymers. More specifically, implementations of the present disclosure generally relate to methods of preparing ultra-high molecular weight terpolymers capable of dissolving at low temperatures.

### Description of the Related Art

When fluids are transported by a pipeline, a drop in fluid pressure typically occurs due to friction between the wall of the pipeline and the fluid. Due to this pressure drop, for a given pipeline, fluids must be transported with sufficient pressure to achieve a desired throughput. In addition, as flow rates increase, the difference in pressure caused by the pressure drop also increases. However, design limitations on pipelines limit the amount of pressure that can be employed. The problems associated with pressure drop are most acute when fluids are transported over long distances. Such pressure drops can result in inefficiencies that increase equipment and operation costs.

To alleviate the problems associated with pressure drop, many in the industry utilize drag-reducing additives in the flowing fluid. When the flow of fluid in a pipeline is turbulent, high molecular weight polymeric drag reducers can be employed to enhance the flow. A drag reducer is capable of substantially reducing friction loss associated with the turbulent flow of fluid through a pipeline. These additives can suppress the growth of turbulent eddies, which results in higher flow rate at a constant pumping pressure. Ultra-high molecular weight polymers are known to function well as drag reducers, particularly in hydrocarbon liquids. In general, drag reduction depends in part upon the molecular weight of the polymer additive and its ability to dissolve in the hydrocarbon under turbulent flow. It has been found that effective drag reduction can be achieved by employing drag-reducing polymers having molecular weights in excess of five million. However, despite these advances in the field of drag-reducing polymers, a need still exists for improved drag reducers.

### SUMMARY

Implementations of the present disclosure generally relate to drag-reducing polymers and methods of manufacturing drag-reducing polymers. More specifically, implementations of the present disclosure generally relate to methods of preparing ultra-high molecular weight terpolymers capable of dissolving at low temperatures.

In one aspect, an ultra-high molecular weight terpolymer useful as a drag reducer for hydrocarbons having a molecular weight greater than 1 million is provided. The terpolymer includes (a) a first monomer including a first alpha-olefin monomer having a carbon chain length of between 4 and 9 carbon atoms. The terpolymer further includes (b) a second monomer including a second alpha-olefin monomer having a carbon chain length of between 12 and 15 carbon atoms. The terpolymer further includes (c) a third monomer including a third alpha-olefin monomer having a carbon chain length of between 10 and 11 carbon atoms, wherein the second monomer is present at greater than or at about 15% (molar content).

Implementations can include one or more of the following. The terpolymer includes from about 35% to about 55% (molar content) of the first monomer, from about 25% to about 45% (molar content) of the second monomer, and from about 10% to about 40% (molar content) of the third monomer. The terpolymer includes from about 40% to about 50% (molar content) of the first monomer, from about 30% to about 40% (molar content) of the second monomer, and from about 10% to about 30% (molar content) of the third monomer. The terpolymer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius.

In another aspect, a method of manufacturing an ultra-high molecular weight terpolymer useful as a drag reducer is provided. The method includes (a) bulk polymerizing a monomer mixture. The monomer mixture includes a first monomer including a first alpha-olefin monomer having a carbon chain length of between 4 and 9 carbon atoms, a second monomer including a second alpha-olefin monomer having a carbon chain length of between 12 and 15 carbon atoms, wherein the second monomer is present at greater than or at about 15% (molar content), and a third monomer including a third alpha-olefin monomer having a carbon chain length of between 10 and 11 carbon atoms. The method further includes (b) forming the ultra-high molecular weight terpolymer, wherein the ultra-high molecular weight terpolymer has a molecular weight of greater than 1 million.

Implementations can include one or more of the following. The terpolymer includes from about 35% to about 55% (molar content) of the first monomer, from about 25% to about 45% (molar content) of the second monomer, and from about 10% to about 40% (molar content) of the third monomer. The terpolymer includes from about 40% to about 50% (molar content) of the first monomer, from about 30% to about 40% (molar content) of the second monomer, and from about 10% to about 30% (molar content) of the third monomer. The first monomer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius. The monomer mixture further includes an initiator, a catalyst, and a promoter.

In yet another aspect, a method of injecting a drag-reducing polymer formulation is provided. The method includes forming an ultra-high molecular weight terpolymer and injecting the ultra-high molecular weight terpolymer into a crude oil pipeline.

Implementations can include one or more of the following. The ultra-high molecular weight terpolymer suppresses the growth of turbulent eddies in the crude oil pipeline. The ultra-high molecular weight terpolymer has a weight average molecular weight of at least 1,000,000 g/mol.

In yet another aspect, a method for preparing a drag-reducing terpolymer suspension is provided. The method includes (a) preparing an ultra-high molecular weight terpolymer by co-polymerizing a monomer mixture including a first monomer including a first alpha-olefin monomer having a carbon chain length of between 4 and 9 carbon atoms, a second monomer including a second alpha-olefin monomer having a carbon chain length of between 12 and 15 carbon atoms, and a third monomer including a third alpha-olefin monomer having a carbon chain length of between 10 and 11 carbon atoms, wherein the second monomer is present at greater than or at about 15% (molar content) and the ultra-high molecular weight terpolymer has a molecular weight greater than 1 million. The method further includes (b) mixing the ultra-high molecular weight terpolymer with a suspending fluid to form the drag-reducing polymer suspension.

Implementations can include one or more of the following. The method further includes grinding the ultra-high molecular weight terpolymer at a temperature below the glass-transition temperature of the ultra-high molecular weight terpolymer to form ground polymer particles. The ultra-high molecular weight terpolymer further includes mixing the monomer mixture with an initiator, a promoter, or both and mixing the monomer mixture with a catalyst. The suspending fluid further includes a wetting agent, an antifoaming agent, a thickening agent, or combinations thereof. The ultra-high molecular weight terpolymer includes from about 35% to about 55% (molar content) of the first monomer, from about 25% to about 45% (molar content) of the second monomer, and from about 10% to about 40% (molar content) of the third monomer. The ultra-high molecular weight terpolymer includes from about 40% to about 50% (molar content) of the first monomer, from about 30% to about 40% (molar content) of the second monomer, and from about 10% to about 30% (molar content) of the third monomer. The first monomer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius.

In yet another aspect, an ultra-high molecular weight terpolymer useful as a drag reducer for hydrocarbons having a molecular weight greater than 1 million is provided. The terpolymer includes (a) a first monomer comprising a first alpha-olefin monomer having a carbon chain length of 8 carbon atoms or less. The terpolymer further includes (b) a second monomer comprising a second alpha-olefin monomer having a carbon chain length of 12 carbon atoms or more. The terpolymer further includes (c) a third monomer comprising a third alpha-olefin monomer having a carbon chain length of between 10 and 11 carbon atoms, wherein the second monomer is present at greater than or at about 15% (molar content).

Implementations can include one or more of the following. The ultra-high molecular weight terpolymer includes from about 35% to about 45% (molar content) of the first monomer, from about 35% to about 45% (molar content) of the second monomer, and from about 10% to about 30% (molar content) of the third monomer. The ultra-high molecular weight terpolymer includes from about 35% to about 55% (molar content) of the first monomer, from about 25% to about 45% (molar content) of the second monomer, and from about 10% to about 40% (molar content) of the third monomer. The ultra-high molecular weight terpolymer includes from about 40% to about 50% (molar content) of the first monomer, from about 30% to about 40% (molar content) of the second monomer, and from about 10% to about 30% (molar content) of the third monomer. The first monomer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius.

### BRIEF DESCRIPTION OF THE DRAWINGS

So that the manner in which the above-recited features of the present disclosure can be understood in detail, a more particular description of the implementations, briefly summarized above, can be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 is a schematic illustration of a system for manufacturing a drag-reducing polymer suspension according to one or more implementations of the present disclosure.

FIG. 2 is a schematic illustration of flow loop test apparatus used to measure the drag reduction performance of polymers formed according to one or more implementations of the present disclosure.

FIG. 3 is a schematic illustration of a test apparatus used to perform dissolution rate tests on various drag reducers.

FIG. 4 is an isometric view of a stirrer employed in the dissolution rate tests.

To facilitate understanding, identical reference numerals have been used, where possible, to designate identical elements that are common to the figures. It is contemplated that elements and features of one implementation can be beneficially incorporated in other implementations without further recitation.

### DETAILED DESCRIPTION

The following disclosure describes drag-reducing polymer compositions and methods for manufacturing drag-reducing polymer compositions, which have high dissolution rates in low temperature hydrocarbons. Certain details are set forth in the following description to provide a thorough understanding of various implementations of the disclosure.

Different aspects, implementations and features are defined in detail herein. Each aspect, implementation or feature so defined can be combined with any other aspect(s), implementation(s) or feature(s) (preferred, advantageous or otherwise) unless clearly indicated to the contrary.

As used herein, the singular forms “a,” “an,” and “the” include plural referents unless the context clearly indicates otherwise.

As used herein, the terms “comprising,” “including” and “having” are intended to be inclusive and mean that there can be additional elements other than the listed elements.

As used herein, the term “alpha-olefin” refers to an olefin that has a double bond between the first and second carbon atom. The term “alpha-olefin” includes linear and branched alpha-olefins unless expressly stated otherwise. In the case of branched alpha-olefins, a branch can be at the 2-position (a vinylidene olefin) and/or the 3-position or higher with respect to the olefin double bond. The term “alpha-olefin,” by itself, does not indicate the presence or absence of heteroatoms and/or the presence or absence of other carbon-carbon double bonds unless explicitly indicated. The term “hydrocarbon alpha-olefin” or “alpha-olefin hydrocarbon” refers to alpha-olefin compounds containing only hydrogen and carbon. The terms “alpha-olefin” and “terminal olefin” can be used interchangeably.

As used herein, the term “alpha-mono-olefin” refers to a linear hydrocarbon mono-olefin having a double bond between the first and second carbon atom. Examples of alpha-mono-olefins include 1-hexene, 1-heptene, 1-octene, 1-nonene, 1-decene, 1-dodecene, 1-tridecene, 1-tetradecene, 1-hexadecene, 1-octadecene, 1-eicosene, 1-docosene, and the like. The terms “alpha-mono-olefin” and “1-olefin” can be used interchangeably.

As used herein, the term “medium crude oil” refers to crude oil having an API gravity between 23° and 33° API.

Drag-reducing polymers with high order regions can manifest a reluctance to dissolve in certain hydrocarbons, particularly when the hydrocarbon is cold, for example, at temperatures less than about 23 degrees Celsius (75 degrees Fahrenheit). In some instances, drag-reducing polymers are pre-treated to help with the dissolution rate of the drag-reducing polymer in hydrocarbons at lower temperature. However, even after pre-treatment, dissolution of some drag-reducing polymers in lower temperature hydrocarbons is still slow. These dissolution rate problems are particularly noticeable in medium and heavy crude oils at temperatures below about 23 degrees Celsius.

In some implementations of the present disclosure, drag-reducing polymers are disclosed that exhibit high dissolution rates in hydrocarbons at low temperatures. These drag-reducing polymers are terpolymers having an amount of alpha-olefin monomers of twelve carbon chain length or longer, for example, dodecene or longer monomers, such as tetradecene. The terpolymer can include more than 25% dodecene or longer monomers, preferably more than 30% dodecene, more preferably more than 35% dodecene, and most preferably more than 40% dodecene. The terpolymer can be an ultra-high molecular weight terpolymer having a molecular weight greater than one million.

In some implementations, the terpolymer can include a first monomer comprising a first alpha-olefin monomer having a carbon chain length of between 4 and 9 carbon atoms. The terpolymer can further include a second monomer comprising a second alpha-olefin monomer having a carbon chain length of between 12 and 15 carbon atoms. The terpolymer can further include a third monomer comprising a third alpha-olefin monomer having a carbon chain length of between 10 and 11 carbon atoms. In one example, the first monomer includes 1-octene, the second monomer includes 1-tetradecene, and the third monomer includes 1-decene. Exemplary compositions of the terpolymer include 40% 1-tetradecene/40% 1-octene/20% 1-decene, 45% 1-tetradecene/35% 1-octene/20% 1-decene, 35% 1-tetradecene/45% 1-octene/20% 1-decene, and 30% 1-tetradecene/40% 1-octene/30% 1-decene.

In some implementations, the terpolymer can include a first monomer comprising a first alpha-olefin monomer having a carbon chain length of 8 carbon atoms or less. The terpolymer can further include a second monomer comprising a second alpha-olefin monomer having a carbon chain length of 12 carbon atoms or more. The terpolymer can further include a third monomer comprising a third alpha-olefin monomer having a carbon chain length of between 10 and 11 carbon atoms.

In some implementations, the terpolymer includes from about 35% to about 55% (molar content) of the first monomer, for example, from about 40% to about 50% (molar content) of the first monomer; from about 15% to about 45% (molar content) of the second monomer, for example, from about 20% to about 45%, from about 25% to about 45%, or from about 30% to about 40% (molar content) of the second monomer; and from about 10% to about 40% (molar content) of the third monomer, for example, from about 10% to about 30% (molar content) of the third monomer.

In some implementations, the terpolymer can include at least 35%, 40%, 45%, or 50% of the first monomer. The terpolymer can include up to 40%, 45%, 50%, or 55% of the first monomer. The terpolymer can include at least 15%, 20%, 25%, 30%, 35%, or 40% of the second monomer. The terpolymer can include up to 30%, 35%, 40%, or 45% of the second monomer. The terpolymer can include at least 10%, 15%, 20%, 25%, 30%, or 35% of the third monomer. The terpolymer can include up to 15%, 20%, 25%, 30%, 35%, or 40% of the third monomer.

The drag-reducing terpolymer can be formed through bulk polymerization, although those of skill in the art will appreciate that other methods are also acceptable, such as solution polymerization. When produced through bulk polymerization, the polymerization medium includes primarily catalyst and alpha-olefin monomers. Although some diluent hydrocarbons can be present, nearly all reactive monomers are normally reacted. The reaction medium can include at least 80% reactive monomers by weight, and normally these monomers are nearly completely reacted, resulting in polymer contents of normally at least 80% by weight of the total reaction medium, based on the total reactor content. In one example, the monomers include at least 90% by weight of the total reaction medium, resulting in final polymer contents of normally at least 90% by weight of the total reaction medium. In another example, the monomers comprise at least 95% by weight of the total reaction medium, resulting in final polymer contents of normally at least 95% by weight of the total reaction medium.

The bulk polymerizations of the present disclosure can be carried out using any alpha-olefin polymerization catalyst, but Ziegler-Natta catalysts are preferred. The Ziegler-Natta catalysts used can be any of those described in the art. Particularly useful materials are those described in U.S. Pat. Nos. 4,945,142, 4,358,572, 4,371,455, 4,415,714, 4,333,123, 4,493,903 and 4,493,904, which are hereby incorporated by reference. Suitable Ziegler-Natta catalysts include materials such as a titanium trihalide and organometallic co-catalysts such as aluminum alkyls or aluminum halides as represented by triethylaluminum and diethylaluminum halide. Appropriate metallocene catalysts can also be used. In bulk polymerization systems, catalysts are used typically at a concentration of 3500 moles monomer per mole transition metal halide in the catalyst, although ratios can vary from as low of 500/1 to as high as 10000/1 or more. Catalyst concentration affects rate of reaction and temperature as well as molecular weight. These catalysts often can be used in the presence of a promoter, such as dibutyl ether, or an initiator, such as diisobutyl aluminum chloride (DIBAC).

For polymerization reactions that are incomplete, removal of unreacted monomers can be carried out by vacuum drying and/or vacuum drying with precipitation according to well-known techniques. However, a bulk reaction can be carried out to substantial completion, for example to 99% completion or more, without the drying step to remove monomer and/or solvent.

Bulk polymerization reactions of the present disclosure are exothermic reactions. It is preferable to control the heat transfer and/or temperature rise in bulk polymerizations in order to obtain the ultra-high molecular weights for best drag reduction. In a typical experiment, the catalyst and monomers are combined in a reaction vessel and agitated at ambient conditions for a period of time sufficient to increase viscosity of the reaction mixture sufficiently to suspend the catalyst and then placed into a cool environment to allow the reaction to proceed. The cool environment is normally maintained at a temperature from about −20 degrees Celsius to about 25 degrees Celsius (about −4 degrees Fahrenheit to about 80 degrees Fahrenheit), allowing the reaction to proceed at a relatively constant pace, while removing heat and forming high molecular weight terpolymers. Conversions of more than 95% can be obtained, with 99% preferred. Depending on the monomers and catalyst used and reaction conditions, reaching such conversion levels may require longer reaction times, typically in the range of from about one hour to several days.

The drag-reducing terpolymers of the present disclosure can also be made by solution polymerization of the monomers followed by removal of the solvent. In solution polymerization, the hydrocarbon solvent, catalyst, and monomers are combined in a reaction vessel and agitated under a nitrogen atmosphere at ambient pressure. In one example, the reaction vessel is cooled either prior to the reaction or during the reaction, depending on the equipment used, conversion desired, and concerns over polymeric degradation. As the solution becomes viscous, the agitation is discontinued and the reaction is allowed to proceed to greater than 50% conversion, preferably greater than 95% conversion, and most preferably greater than 99% conversion. After completion of the polymerization, the polymer solution can be contacted with a non-solvent to precipitate the polymer and extract the polymerization solvent and unreacted monomer, for example, as is taught by Johnston, et al. in U.S. Pat. No. 5,376,697, which is incorporated by reference. The resulting polymer can then be dried. Alternatively, if the hydrocarbon solvent boils at a low temperature, it can be removed by heating, exposure to vacuum, or both. Combinations of extraction by a non-solvent, heating and/or vacuum can be used as should be apparent to one skilled in the art.

In some implementations, an effective drag-reducing polymer within the scope of the present disclosure should have a molecular weight in excess of 1 million, for example, a molecular weight in excess of 5 million.

The ultra-high molecular weight terpolymer of the present disclosure can be ground at temperatures below the glass-transition temperature of the polymer and then mixed in a carrier fluid. Glass-transition temperatures vary with the type of polymer and typically range between −10 degrees Celsius to −100 degrees Celsius (14 degrees Fahrenheit and −148 degrees Fahrenheit). This temperature can vary depending upon the glass-transition point of the particular terpolymer, but normally such temperatures must be below the lowest glass-transition point of a polymer that comprises a polymer blend.

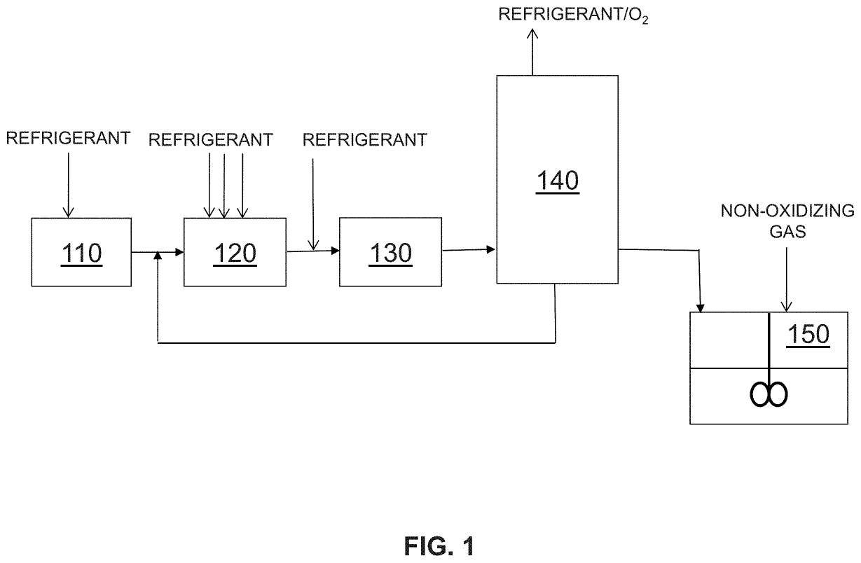

As shown in FIG. 1, the ultra-high molecular weight terpolymer is conveyed to a coarse grinder 110. The coarse grinder 110 chops large chunks of terpolymer into small polymer pieces, typically between 1¼ to 1½ centimeters (½″ to ⅝″) in diameter. The coarse chopper 110 can be operated at ambient temperatures. In one example, the polymer in the coarse chopper 110 can be cooled to from 5 degrees Celsius to 15 degrees Celsius (from 41 degrees Fahrenheit to 59 degrees Fahrenheit). The polymer in the coarse chopper 110 can be cooled either internally or externally, or both, with a liquid, gaseous, or solid refrigerant, or a combination thereof. In one example, the polymer is cooled by spraying a liquid refrigerant into the coarse chopper 110, such as liquid nitrogen, liquid helium, liquid argon, or a mixture of two or more such refrigerants.

The small polymer pieces formed in the coarse chopper 110 are then transported to a pre-cooler 120. This transport can be accomplished by any number of typical solids handling methods. In one example, transport is accomplished through the use of an auger or a pneumatic transport system. The pre-cooler 120 can be an enclosed screw conveyor with nozzles for spraying a liquid refrigerant, such as liquid nitrogen, liquid helium, liquid argon, or mixtures thereof onto the small polymer pieces. While a gaseous refrigerant can also be used alone, the cooling efficiency is often too low. The pre-cooler 120 reduces the temperature of the small polymer pieces to a temperature below the glass-transition temperature of the polymer. In one example, this temperature is below −130 degrees Celsius (−202 degrees Fahrenheit), for example, below −150 degrees Celsius (−238 degrees Fahrenheit). These temperatures can be produced by any known methods, but use of liquid refrigerant such as that consisting essentially of liquid nitrogen, helium, argon, or a mixture of two or more such refrigerants sprayed directly onto the polymer is preferred as the resulting atmosphere reduces or eliminates flammability hazards that exist when polymer particles are mixed with an oxygen-containing atmosphere. The rate of addition of the liquid refrigerant can be adjusted to maintain the polymer within the preferred temperature range.

After the small polymer pieces are cooled in the pre-cooler 120, the small polymer pieces are transported to a cryomill 130. Again, this transport can be accomplished by any typical solids handling method, but often by an auger or a pneumatic transport system. A liquid refrigerant can be added to the cryomill 130 in order to maintain the temperature of the polymer in the cryomill 130 below the glass-transition temperature of the ultra-high molecular weight terpolymer. In one implementation, the liquid refrigerant is added to the small polymer pieces at the entrance to the cryomill 130. The temperature of the cryomill 130 is maintained at a temperature below the glass-transition temperature. In one example, the temperature of the cryomill is maintained at from about −130 degrees Celsius to about −155 degrees Celsius (−202 degrees Fahrenheit to −247 degrees Fahrenheit). The cryomill 130 can be any type of cryomill known in the art, such as a hammer mill or an attrition mill. The cryomill 130 reduces the particle size of small polymer pieces it receives from the pre-cooler 120.

The particles formed in the cryomill 130 are then transferred to a separator 140. Most of the liquid refrigerant vaporizes in separator 140. The separator 140 acts to separate the primarily vaporized refrigerant atmosphere from the solid polymer particles, and the larger polymer particles from the small polymer particles. The separator 140 can be any known separator suitable for separating particles of this size, including a rotating sieve, vibrating sieve, centrifugal sifter and a cyclone separator. The separator 140 vents a portion of the primarily vaporized refrigerant atmosphere from the cryomill 130, and separates particles into a first fraction with less than a set minimum diameter from a second fraction having diameters higher than the set minimum diameter. The second fraction of particles of having diameters higher than the set minimum diameter is discarded or returned for recycle purposes to the pre-cooler 120 for re-grinding. The first fraction of those particles of having diameters lower than the set minimum diameter is then transported to a mix tank 150. A person of ordinary skill in the art will be able to select the proper set minimum diameter, which can depend upon the separator, operating conditions, and desired end use, to optimize the final suspension properties.

Optionally; a partitioning agent can be added to the polymer during grinding to help prevent the freshly exposed surfaces of the polymer from sticking together. Examples of suitable partitioning agents useful in implementations of the present disclosure include, but are not limited to, alumina, silica, calcined clay; talc; carbon black, calcium stearate, and/or magnesium stearate. The amount of partitioning agent employed in the grinding process can be less than about 35 weight percent, less than about 30 weight percent, or less than 25 weight percent based on the total weight of the polymer and partitioning agent.

The small polymer particles (first fraction) are mixed with a suspending fluid in the mix tank 150 to form a suspending fluid and polymer particles mixture. The suspending fluid is any liquid that is a non-solvent for the ultra-high molecular weight terpolymer. Water is most commonly used. For many other mixtures, lower carbon alcohols such as methanol, ethanol or their mixtures, with or without water, may also be used as the suspending fluid. The mix tank 150 forms a suspension of the polymer particles in the suspending fluid. Other components can be added to the mix tank 150 before, during, or after mixing the ground polymer particles with the suspending fluid in order to aid the formation of the suspension, and/or to maintain the suspension. For instance, glycols, such as ethylene glycol or propylene glycol, can be added for freeze protection or as a density balancing agent. In one example, the amount of glycol added ranges from 10% to 60% by weight of the suspending fluid, as needed. A suspension stabilizer can be used to aid in maintaining the suspension of the ultra-high molecular weight, non-tacky polymer particles. Typical suspension stabilizers include talc, resins, tri-calcium phosphate, magnesium stearate, calcium stearate, silica, polyanhydride polymers, sterically hindered alkyl phenol antioxidants, amide waxes such as stearamide, ethylene bis-stearamide and oleamide, and graphite. The amount of the suspension stabilizer can be minimized or eliminated where possible to reduce the amount of material in the suspension that does not act as a drag-reducing agent. In one example, the amount of the suspension stabilizer added ranges from about 0% to about 40% of the suspending fluid, by weight, for example, from about 5% to about 25%, such as from about 8% to about 12% by weight of the suspending fluid, as needed. A wetting agent, such as a surfactant, can be added to aid in the dispersal of the polymer particles to form a uniform mixture. Non-ionic surfactants, such as linear secondary alcohol ethoxylates, linear alcohol ethoxylates, alkylphenol ethoxylates and anionic surfactants such as alkyl benzene sulfonates and alcohol ethoxylate sulfates, for example, sodium lauryl sulfate, are preferred. In one example, the amount of wetting agent added ranges from about 0.01% to about 1° A by weight, such as from about 0.01% to about 0.1° A by weight of the suspending fluid, as needed. In order to prevent foaming of the suspending fluid/polymer particle mixture during agitation, a suitable antifoaming agent can be used, typically a silicon oil based commercially available antifoam. Representative but non-exhaustive examples of antifoaming agents are antifoam agents, trademark of, and sold by, Dow Corning, Midland, Mich. Generally, no more than 1° A of the suspending fluid by weight of the active antifoaming agent is used. The mix tank 150 can be blanketed with a non-oxidizing gas such as nitrogen, argon, neon, carbon dioxide, and carbon monoxide, other similar gases, or the non-oxidizing gas can be sparged into the mix tank 150 during polymer particle addition to reduce the hazard of fire or explosion resulting from the interaction between the small polymer particles.

After the suspending fluid/polymer particle mixture is agitated to form a uniform mixture, a thickening agent can be added to increase the viscosity of the mixture. The increase in viscosity retards separation of the suspension. Typical thickening agents are high molecular weight, water-soluble polymers, including polysaccharides, xanthum gum, carboxymethyl cellulose, hydroxypropyl guar, and hydroxyethyl cellulose. In one example where water is the suspending fluid, the pH of the suspending fluid is basic, preferably above 9, to inhibit the growth of microorganisms.

The product resulting from the agitation in the mix tank is a stable suspension of a drag-reducing polymer in a carrier fluid suitable for use as a drag-reducing agent. This suspension may then be pumped or otherwise transported to storage for later use, or used immediately

The drag-reducing polymer described herein can be employed as a drag reducer in almost any liquid having a hydrocarbon continuous phase. For example, the drag-reducing polymer can be used in pipelines carrying crude oil or various refined products such as gasoline, diesel fuel, fuel oil and naphtha. The drag-reducing polymer is ideally suited for use in pipelines and conduits carrying fluid in turbulent flow conditions and can be injected into the pipeline or conduit using conventional or umbilical delivery systems. The amount of drag-reducing polymer injected is expressed in terms of concentration of polymer in the hydrocarbon-containing fluid. In one example, the concentration of the polymer in the hydrocarbon-containing fluid is from about 0.1 to about 100 ppmw, for example, from about 0.5 to about 50 ppmw, such as, from about 1 to about 20 ppmw, and such as from about 1 to about 5 ppmw.

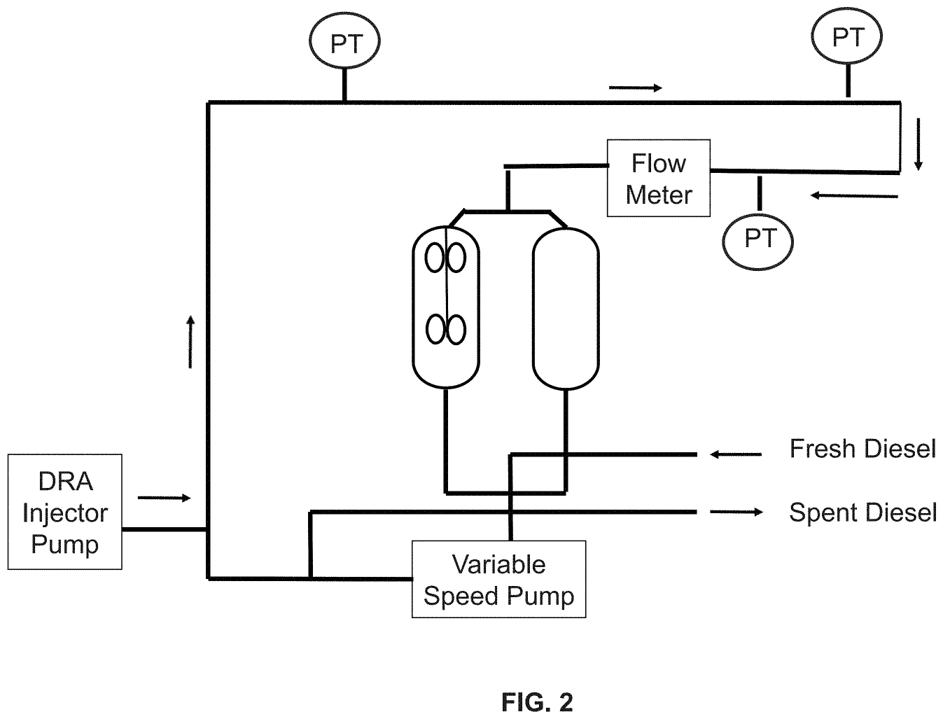

The solubility of the ultra-high molecular weight terpolymer in a hydrocarbon-containing liquid is described herein in terms of a hydrocarbon dissolution rate constant “k.” The dissolution rate of the drag-reducing polymer can be determined through a number of methods. In one implementation, the hydrocarbon dissolution rate constant (k) is determined in the manner described in relation to FIG. 2. The hydrocarbon dissolution rate constant of the drag-reducing polymer (k) in kerosene at 30 degrees Celsius is preferably at least about 0.24 sec⁻¹, more preferably at least about 0.30 sec⁻¹, and most preferably at least about 0.33 sec⁻¹. The hydrocarbon dissolution rate constant of the drag-reducing polymer (k) in kerosene at 10 degrees Celsius is preferably at least about 0.12 sec⁻¹, more preferably at least about 0.20 sec⁻¹, and most preferably at least about 0.22 sec⁻¹. The hydrocarbon dissolution rate constant of the drag-reducing polymer (k) in kerosene at 0 degrees Celsius is preferably at least about 0.05 sec⁻¹, more preferably at least about 0.09 sec⁻¹, and most preferably at least about 0.18 sec⁻¹. The hydrocarbon dissolution rate constant of the drag-reducing polymer (k) in medium crude at −5 degrees Celsius is preferably at least about 0.05 sec⁻¹, more preferably at least about 0.16 sec⁻¹, and most preferably at least about 0.17 sec⁻¹.

In some implementations, the ultra-high molecular weight terpolymer made in accordance with the present disclosure provide significant percent drag reduction (% DR) when injected into a pipeline. Percent drag reduction (% DR) and the manner in which it is calculated are more fully described in Example 2, below. In one example, the terpolymer-based drag-reducer of the present disclosure provides at least about 10% drag reduction, for example, at least about 20% drag reduction, such as, at least 30% drag reduction.

### EXAMPLES

The following non-limiting examples are provided to further illustrate implementations described herein. However, the examples are not intended to be all inclusive and are not intended to limit the scope of the implementations described herein.

### Example 1

A catalyst was prepared by combining, in a primarily nitrogen environment under ambient temperature and pressure, 1.35 grams of TiCl3(AA) with 23.07 grams of purified petroleum distillate, together with 0.96 grams of dibutyl ether promoter according to the teachings of Mack, U.S. Pat. No. 4,416,714. The solution was held for 30 minutes while stirring. The catalyst was then activated using 9.5 grams of an aluminum cocatalyst, a 25% solution of diisobutyl aluminum chloride (DIBAC) in heptane solvent (“25% DIBAC solution”). Again, the mixture was held for 30 minutes while stirring. An octene-decene-tetradecene terpolymer of the present disclosure was prepared in a primarily nitrogen environment under standard temperature and pressure by mixing 1-octene, 1-decene, and 1-tetradecene in a beaker according to the molar ratios depicted in Table I. After stirring, 5.0 milliliters of a 25% DIBAC solution was added to the beaker. The mixture was held for 30 minutes without stirring. A 5.0 milliliter portion of the catalyst mixture prepared was added to the beaker while stirring continuously. The entire mixture was allowed to react. The resulting terpolymers were subsequently tested. The terpolymer conversions, inherent viscosities, and drag reduction performance of the terpolymers are shown in Table I.

TABLE I

| | | | Polymer Properties | | |
|---|---|---|---|---|---|
| | | | Polymer | Inherent | Drag |
| Composition (mole ratio) | | | Conver- | Viscosity | Reduction |
| 1- | 1- | 1- | sions | (deciliter/ | Performance |
| Octene | Decene | Tetradecene | (%) | gram) | Observed (%) |
| 0.25 | 0.5 | 0.25 | 95.28 | 23 | 28.1 |
| 0.125 | 0.5 | 0.375 | 95.43 | 23.2 | 25.4 |
| 0 | 0.75 | 0.25 | 95.24 | 23.9 | 25.7 |
| 0 | 0.625 | 0.375 | 95.02 | 24 | 34 |
| 0.125 | 0.4375 | 0.4375 | 94.92 | 23.6 | 21 |
| 0.25 | 0.275 | 0.375 | 94.98 | 24.1 | 28.7 |
| 0.34 | 0.33 | 0.33 | 95.04 | 23.3 | 17.9 |
| 0.375 | 0.375 | 0.25 | 95.08 | 23.4 | 20 |
| 0.3125 | 0.3125 | 0.375 | 95.16 | 25.7 | 39.5 |
| 0.2 | 0.383 | 0.417 | 94.98 | 25.3 | 34.5 |
| 0.35 | 0.35 | 0.3 | 95.17 | 24.2 | 26 |
| 0.45 | 0.25 | 0.3 | 95.01 | 23.8 | 34 |
| 0.25 | 0.25 | 0.5 | 94.34 | 23 | 15.8 |
| 0.525 | 0.225 | 0.25 | 95.47 | 25.6 | 47.7 |
| 0.49 | 0.21 | 0.3 | 95.26 | 25.9 | 43.3 |
| 0.4375 | 0.1875 | 0.375 | 95.27 | 26.4 | 36.1 |
| 0.35 | 0.15 | 0.5 | 94.69 | 26.3 | 31.9 |
| 0.4 | 0.1 | 0.5 | 94.3 | 23.9 | 19.4 |
| 0.5 | 0.125 | 0.375 | 95.11 | 23.1 | |
| 0.583 | 0 | 0.417 | 94.68 | 23.9 | |

The resulting terpolymers were cryogrinded and suspended in water to produce free-flowing suspensions using the process described in conjunction with FIG. 1.

In this example, the drag reduction capabilities of the terpolymer and terpolymer suspensions prepared in Example 1 were evaluated in diesel. The test device used in this example was a one Loop Test apparatus as shown in FIG. 2. This test allowed for the evaluation of drag reducer performance when injected in predissolved form into the diesel in the flow loop.

A predissolved polymer solution in diesel is injected into the loop so that the polymer concentration is 1.3 ppm in the loop. The diesel was pumped through the loop at 9.97 gpm using a low-shear progressive cavity pump. Pressure drop was measured over a 100-ft section of the pipe loop. Baseline pressure drop was measured during a period of non-injection. Treated pressure drop was measured during the injection of the drag reducer sample. Each test loop run consists of 1) loading the injector pump with the sample solution to be tested, 2) filling the feed tank with fresh diesel 3) recirculating the diesel to generate a baseline pressure drop, 4) injecting the test solution to generate the treated pressure drop, 5) stopping injection and allowing the flow loop to evacuate the treated diesel and return to baseline conditions. Percent drag reduction is the ratio of the difference between the baseline pressure drop (ΔP_{base}) and the treated pressure drop (ΔP_{treated}) to the baseline pressure drop (ΔP_{base}) at a constant flow rate:

% DR=(ΔP_{base}−ΔP_{treated})/ΔP_{base}×100

Table I also depicts the drag reduction performance obtained in the loop for all the synthesized polymers.

The most effective drag reduction typically does not occur until the polymer is dissolved or substantially solvated in the conduit. Thus, the rate at which the polymer dissolves into the crude oil is an important property. The rate at which the polymer dissolves can be determined by a vortex inhibition test at various temperatures. At a constant stirring speed, the depth of the vortex is proportional to the amount of dissolved polymer in the kerosene. The dissolution rate is a first order function: d/dt(Conc_{undissolved})=−k×Conc_{undissolved} wherein k is the dissolution rate constant. The time, T, for a certain fraction of the polymer to be dissolved is a function of k as follows:

T=[ln 100/(100−% dissolved)]/k

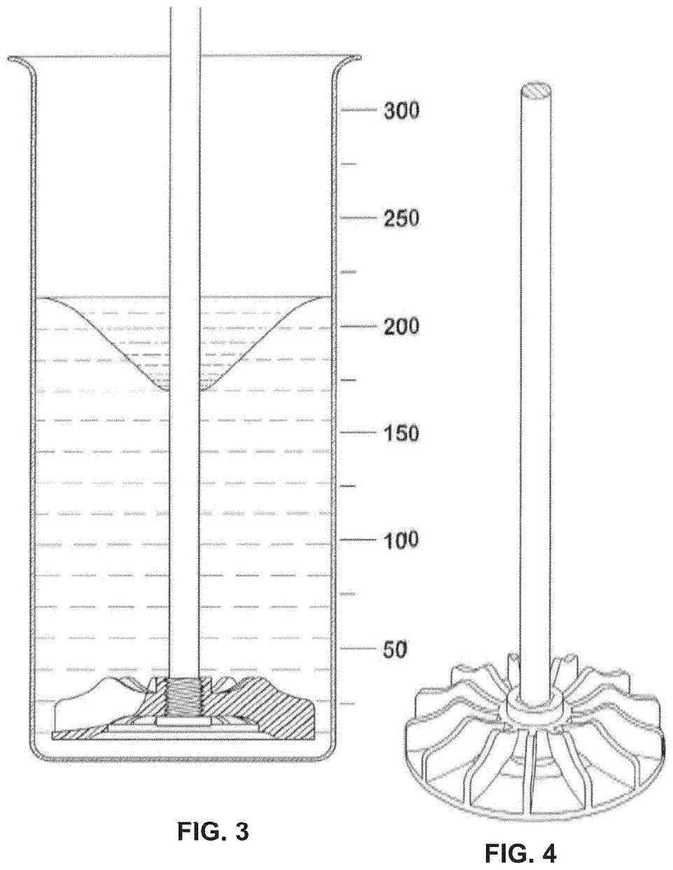

FIG. 3 schematically illustrates the dissolution rate test apparatus used to determine the dissolution rate constant. The dissolution rate test apparatus included a rotating stirrer that was placed in a jacketed graduated 250 mL cylinder having an internal diameter of 48 mm. The upper end of the rotating stirrer was connected to a variable-speed motor (not shown). The specific configuration of the rotating stirrer is illustrated in detail in FIG. 4. The rotating stirrer employed in the dissolution rate tests was a Black & Decker paint stirrer made from a casting of oil resistant plastic. The stirrer head was formed of a 45 mm diameter disk made up of a central disk and an outer ring. The central disk was 20 mm in diameter and 1.5 mm thick and was centered on a hub that was 12 mm in diameter and 12 mm thick. The hub was drilled in the center for attachment of the stirring head to a 4 mm diameter shaft. The shaft was threaded for 27 mm so that two small nuts held the stirring head to the shaft. The outer ring was 45 mm in diameter, 9 mm wide, and 1.5 mm thick. The outer ring was attached to the inner disk by 13 evenly spaced arcs 13 mm long and 1 mm thick. The outer disk resided 6 mm below the level of the inner disk. The arcs that attached the outer ring to the inner disk acted as paddles to stir the fluid in the test cylinder. The shaft that attached the stirring head to the stirring motor (not shown) was 300 mm long. It should be noted that dissolution rate test results can vary somewhat if different stirrer configurations are used.

To conduct the dissolution rate test, the stirrer was positioned inside the cylinder and adjusted so that the bottom of stirrer head was about 5 millimeters from the bottom of the cylinder. The cylinder jacket was then filled with water recirculated from a recirculating water bath with controlled heating and cooling capability. The desired temperature was selected and the bath was allowed to reach that temperature. The jacketed graduated cylinder was filled with kerosene to the 200 mL line with the stirrer in place. The circulation of cooling fluid through the graduated cylinder jacket was initiated. The kerosene inside the graduated cylinder was stirred for sufficient time to allow the temperature to equilibrate at the set temperature, usually 10-15 minutes. The kerosene temperature was checked with a thermometer to ensure that the kerosene was at the desired test temperature. The speed of the motor was adjusted to stir rapidly enough to form a vortex in the kerosene that reached to the 125 mL graduation in the cylinder.

A 0.25 mL aliquot of the terpolymer was added to the stirring kerosene mixture with the vortex established at the 125 mL mark. The aliquot of the terpolymer was added to the kerosene at the desired temperature, as indicated in Table II below. A timer was used to monitor and record the time required for the vortex to recede to each of the 5 mL increments on the cylinder: 130, 135, 140, and so on. However, the determination was stopped when the time exceeded 30 minutes. The position of the vortex at the end of 30 minutes is designated as Vf.

The dissolution rate constant, k, was calculated from the slope of a plot of the log of the relative vortex against time. The relative vortex is the decimal fraction of the relationship

[Vf−Vt]/[Vf−Vi]

where Vf is the final reading at the maximum vortex suppression within the 30 minute timeframe of the experiment, Vi is the initial vortex reading prior to addition of drag-reducing polymer (which is routinely set at the 125 mL mark), and Vt is the vortex reading at the specified marks 130, 135, 140, and so on up to the reading at the maximum vortex suppression. A linear regression analysis was performed on the plot of the log of the relative vortex against time. The resulting slope of the data gave the dissolution rate constant, k, for a given temperature and concentration of active polymer when multiplied by −2.303. Any of the polymers in Table II having a dissolution rate below 0.04 (1/s) were labeled as a fail. Previous experience has demonstrated that dissolution rates below 0.04 (1/s) fail to dissolve sufficiently in medium crude oils and thus do not provide any meaningful drag reduction performance.

The dissolution rates for temperatures of 30 degrees Celsius; 10 degrees Celsius; 0 degrees Celsius; and −5 degrees Celsius are depicted in Table II.

TABLE II

| Composition (mole ratio) | | | Dissolution rates (1/s) | | | |
|---|---|---|---|---|---|---|
| 1- | 1- | 1- | T = | T = | T = | T = |
| Octene | Decene | Tetradecene | 30C | 10C | 0C | −5C |
| 0.25 | 0.5 | 0.25 | 0.35 | 0.09 | 0.04 | 0.04 |
| 0.125 | 0.5 | 0.375 | 0.26 | 0.02 | 0.01 | 0.00 |
| 0 | 0.75 | 0.25 | 0.34 | 0.04 | 0.00 | 0.00 |
| 0 | 0.625 | 0.375 | 0.28 | 0.02 | 0.00 | 0.00 |
| 0.125 | 0.4375 | 0.4375 | 0.16 | 0.04 | 0.00 | 0.00 |
| 0.25 | 0.275 | 0.375 | 0.23 | 0.04 | 0.03 | 0.03 |
| 0.34 | 0.33 | 0.33 | 0.24 | 0.09 | 0.04 | 0.02 |
| 0.375 | 0.375 | 0.25 | 0.28 | 0.20 | 0.15 | 0.11 |
| 0.3125 | 0.3125 | 0.375 | 0.23 | 0.07 | 0.04 | 0.03 |
| 0.2 | 0.383 | 0.417 | 0.20 | 0.03 | 0.00 | 0.00 |
| 0.35 | 0.35 | 0.3 | 0.23 | 0.11 | 0.09 | 0.07 |
| 0.45 | 0.25 | 0.3 | 0.21 | 0.13 | 0.08 | 0.05 |
| 0.25 | 0.25 | 0.5 | 0.07 | 0.02 | 0.00 | 0.00 |
| 0.525 | 0.225 | 0.25 | 0.31 | 0.35 | 0.30 | 0.32 |
| 0.49 | 0.21 | 0.3 | 0.30 | 0.20 | 0.18 | 0.16 |
| 0.4375 | 0.1875 | 0.375 | 0.33 | 0.22 | 0.18 | 0.17 |
| 0.35 | 0.15 | 0.5 | 0.13 | 0.03 | 0.03 | 0.00 |
| 0.4 | 0.1 | 0.5 | 0.13 | 0.03 | 0.01 | 0.00 |
| 0.5 | 0.125 | 0.375 | 0.24 | 0.12 | 0.05 | 0.05 |
| 0.583 | 0 | 0.417 | 0.22 | 0.06 | 0.03 | 0.03 |

In one embodiment, an ultra-high molecular weight terpolymer useful as a drag reducer for hydrocarbons having a molecular weight greater than 1 million is provided. The terpolymer includes (a) a first monomer including a first alpha-olefin monomer having a carbon chain length of between 4 and 9 carbon atoms. The terpolymer further includes (b) a second monomer including a second alpha-olefin monomer having a carbon chain length of between 12 and 15 carbon atoms. The terpolymer further includes (c) a third monomer including a third alpha-olefin monomer having a carbon chain length of between 10 and 11 carbon atoms, wherein the second monomer is present at greater than or at about 15% (molar content).

Implementations of any of the embodiments described herein can include one or more of the following. The terpolymer includes from about 35% to about 55% (molar content) of the first monomer, from about 25% to about 45% (molar content) of the second monomer, and from about 10% to about 40% (molar content) of the third monomer. The terpolymer includes from about 40% to about 50% (molar content) of the first monomer, from about 30% to about 40% (molar content) of the second monomer, and from about 10% to about 30% (molar content) of the third monomer. The terpolymer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius.

In another embodiment, a method of manufacturing an ultra-high molecular weight terpolymer useful as a drag reducer is provided. The method includes (a) bulk polymerizing a monomer mixture. The monomer mixture includes a first monomer including a first alpha-olefin monomer having a carbon chain length of between 4 and 9 carbon atoms, a second monomer including a second alpha-olefin monomer having a carbon chain length of between 12 and 15 carbon atoms, wherein the second monomer is present at greater than or at about 15% (molar content), and a third monomer including a third alpha-olefin monomer having a carbon chain length of between 10 and 11 carbon atoms. The method further includes (b) forming the ultra-high molecular weight terpolymer, wherein the ultra-high molecular weight terpolymer has a molecular weight of greater than 1 million.

Implementations of any of the embodiments described herein can include one or more of the following. The terpolymer includes from about 35% to about 55% (molar content) of the first monomer, from about 25% to about 45% (molar content) of the second monomer, and from about 10% to about 40% (molar content) of the third monomer. The terpolymer includes from about 40% to about 50% (molar content) of the first monomer, from about 30% to about 40% (molar content) of the second monomer, and from about 10% to about 30% (molar content) of the third monomer. The first monomer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius. The monomer mixture further includes an initiator, a catalyst, and a promoter.

In yet another embodiment, a method of injecting a drag-reducing polymer formulation is provided. The method includes forming an ultra-high molecular weight terpolymer and injecting the ultra-high molecular weight terpolymer into a crude oil pipeline.

Implementations of any of the embodiments described herein can include one or more of the following. The ultra-high molecular weight terpolymer suppresses the growth of turbulent eddies in the crude oil pipeline. The ultra-high molecular weight terpolymer has a weight average molecular weight of at least 1,000,000 g/mol.

In yet another embodiment, a method for preparing a drag-reducing terpolymer suspension is provided. The method includes (a) preparing an ultra-high molecular weight terpolymer by co-polymerizing a monomer mixture including a first monomer including a first alpha-olefin monomer having a carbon chain length of between 4 and 9 carbon atoms, a second monomer including a second alpha-olefin monomer having a carbon chain length of between 12 and 15 carbon atoms, and a third monomer including a third alpha-olefin monomer having a carbon chain length of between 10 and 11 carbon atoms, wherein the second monomer is present at greater than or at about 15% (molar content) and the ultra-high molecular weight terpolymer has a molecular weight greater than 1 million. The method further includes (b) mixing the ultra-high molecular weight terpolymer with a suspending fluid to form the drag-reducing polymer suspension.

Implementations of any of the embodiments described herein can include one or more of the following. The method further includes grinding the ultra-high molecular weight terpolymer at a temperature below the glass-transition temperature of the ultra-high molecular weight terpolymer to form ground polymer particles. The ultra-high molecular weight terpolymer further includes mixing the monomer mixture with an initiator, a promoter, or both and mixing the monomer mixture with a catalyst. The suspending fluid further includes a wetting agent, an antifoaming agent, a thickening agent, or combinations thereof. The ultra-high molecular weight terpolymer includes from about 35% to about 55% (molar content) of the first monomer, from about 25% to about 45% (molar content) of the second monomer, and from about 10% to about 40% (molar content) of the third monomer. The ultra-high molecular weight terpolymer includes from about 40% to about 50% (molar content) of the first monomer, from about 30% to about 40% (molar content) of the second monomer, and from about 10% to about 30% (molar content) of the third monomer. The first monomer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius.

In yet another embodiment, an ultra-high molecular weight terpolymer useful as a drag reducer for hydrocarbons having a molecular weight greater than 1 million is provided. The terpolymer includes (a) a first monomer comprising a first alpha-olefin monomer having a carbon chain length of 8 carbon atoms or less. The terpolymer further includes (b) a second monomer comprising a second alpha-olefin monomer having a carbon chain length of 12 carbon atoms or more. The terpolymer further includes (c) a third monomer comprising a third alpha-olefin monomer having a carbon chain length of between 10 and 11 carbon atoms, wherein the second monomer is present at greater than or at about 15% (molar content).

Implementations of any of the embodiments described herein can include one or more of the following. The ultra-high molecular weight terpolymer includes from about 35% to about 45% (molar content) of the first monomer, from about 35% to about 45% (molar content) of the second monomer, and from about 10% to about 30% (molar content) of the third monomer. The ultra-high molecular weight terpolymer includes from about 35% to about 55% (molar content) of the first monomer, from about 25% to about 45% (molar content) of the second monomer, and from about 10% to about 40% (molar content) of the third monomer. The ultra-high molecular weight terpolymer includes from about 40% to about 50% (molar content) of the first monomer, from about 30% to about 40% (molar content) of the second monomer, and from about 10% to about 30% (molar content) of the third monomer. The first monomer includes 1-octene, the second monomer includes 1-tetradecene, and the third monomer includes 1-decene. The terpolymer has a dissolution rate constant being at least about 0.04 sec⁻¹ in kerosene at a temperature of 0 degrees Celsius. The terpolymer has a dissolution rate constant being at least about 0.10 sec⁻¹ in kerosene at a temperature of 0 degrees Celsius.

While the foregoing is directed to implementations of the present disclosure, other and further implementations of the present disclosure can be devised without departing from the basic scope thereof, and the scope thereof is determined by the claims that follow.

1. An ultra-high molecular weight terpolymer useful as a drag reducer for hydrocarbons having a molecular weight greater than 1 million, comprising:
(a) a first monomer comprising a first alpha-olefin monomer having a carbon chain length of between 4 and 9 carbon atoms;
(b) a second monomer comprising a second alpha-olefin monomer having a carbon chain length of between 12 and 15 carbon atoms; and
(c) a third monomer comprising a third alpha-olefin monomer having a carbon chain length of between 10 and 11 carbon atoms, wherein the second monomer is present at greater than or at about 15% (molar content).

2. The terpolymer of claim 1, wherein the ultra-high molecular weight terpolymer comprises:
from about 35% to about 55% (molar content) of the first monomer;
from about 15% to about 45% (molar content) of the second monomer; and
from about 10% to about 40% (molar content) of the third monomer.

3. The terpolymer of claim 2, wherein the ultra-high molecular weight terpolymer comprises:
from about 40% to about 50% (molar content) of the first monomer;
from about 30% to about 40% (molar content) of the second monomer; and
from about 10% to about 30% (molar content) of the third monomer.

4. The terpolymer of claim 3, wherein the first monomer comprises 1-octene, the second monomer comprises 1-tetradecene, and the third monomer comprises 1-decene.

5. The terpolymer of claim 1, wherein the terpolymer has a dissolution rate constant being at least about 0.04 sec⁻¹ in kerosene at a temperature of 0 degrees Celsius.

6. The terpolymer of claim 4, wherein the terpolymer has a dissolution rate constant being at least about 0.10 sec⁻¹ in kerosene at a temperature of 0 degrees Celsius.

7. A method of manufacturing an ultra-high molecular weight terpolymer useful as a drag reducer, comprising:
(a) bulk polymerizing a monomer mixture comprising:
a first monomer comprising a first alpha-olefin monomer having a carbon chain length of between 4 and 9 carbon atoms;
a second monomer comprising a second alpha-olefin monomer having a carbon chain length of between 12 and 15 carbon atoms, wherein the second monomer is present at greater than or at about 15% (molar content); and
a third monomer comprising a third alpha-olefin monomer having a carbon chain length of between 10 and 11 carbon atoms; and
(b) forming the ultra-high molecular weight terpolymer, wherein the ultra-high molecular weight terpolymer has a molecular weight of greater than 1 million.

8. The method of claim 7, wherein the ultra-high molecular weight terpolymer comprises:
from about 35% to about 55% (molar content) of the first monomer;
from about 15% to about 45% (molar content) of the second monomer; and
from about 10% to about 40% (molar content) of the third monomer.

9. The method of claim 8, wherein the ultra-high molecular weight terpolymer comprises:
from about 40% to about 50% (molar content) of the first monomer;
from about 30% to about 40% (molar content) of the second monomer; and
from about 10% to about 30% (molar content) of the third monomer.

10. The method of claim 9, wherein the first monomer comprises 1-octene, the second monomer comprises 1-tetradecene, and the third monomer comprises 1-decene.

11. The method of claim 7, wherein the terpolymer has a dissolution rate constant being at least about 0.04 sec⁻¹ in kerosene at a temperature of 0 degrees Celsius.

12. The method of claim 10, wherein the terpolymer has a dissolution rate constant being at least about 0.10 sec⁻¹ in kerosene at a temperature of 0 degrees Celsius.

13. The method of claim 7, wherein the monomer mixture further comprises an initiator, a catalyst, and a promoter.

14. A method of injecting a drag-reducing polymer formulation, comprising:
forming an ultra-high molecular weight terpolymer according to the method of any of claim 7; and
injecting the ultra-high molecular weight terpolymer into a crude oil pipeline.

15. The method of claim 14, wherein the ultra-high molecular weight terpolymer suppresses the growth of turbulent eddies in the crude oil pipeline.

16. The method of claim 14, wherein the ultra-high molecular weight terpolymer has a weight average molecular weight of at least 1,000,000 g/mol.

17. A method for preparing a drag-reducing terpolymer suspension, comprising:
(a) preparing an ultra-high molecular weight terpolymer by co-polymerizing a monomer mixture comprising a first monomer comprising:
a first alpha-olefin monomer having a carbon chain length of between 4 and 9 carbon atoms;
a second monomer comprising a second alpha-olefin monomer having a carbon chain length of between 12 and 15 carbon atoms; and
a third monomer comprising a third alpha-olefin monomer having a carbon chain length of between 10 and 11 carbon atoms, wherein the second monomer is present at greater than or at about 15% (molar content) and the ultra-high molecular weight terpolymer has a molecular weight greater than 1 million; and
(b) mixing the ultra-high molecular weight terpolymer with a suspending fluid to form the drag-reducing terpolymer suspension.

18. The method of claim 17, further comprising, grinding the ultra-high molecular weight terpolymer at a temperature below the glass-transition temperature of the ultra-high molecular weight terpolymer to form ground polymer particles.

19. The method of claim 17, wherein preparing the ultra-high molecular weight terpolymer further comprises:
mixing the monomer mixture with an initiator, a promoter, or both; and
mixing the monomer mixture with a catalyst.

20. The method of claim 17, wherein the suspending fluid further comprises a wetting agent, an antifoaming agent, a thickening agent, or combinations thereof.
